(19) United States
(12) Patent Application Publication
(10) Pub. No.: US 2023/0082848 A1
(43) Pub. Date: Mar. 16, 2023

(54) MACHINE LEARNING MODEL EVALUATION SYSTEM AND METHOD

(71) Applicant: KABUSHIKI KAISHA TOSHIBA, Tokyo (JP)

(72) Inventors: Takahiro TANAKA, Akishima (JP); Kenichi DONIWA, Asaka (JP); Kosuke HARUKI, Tachikawa (JP); Masahiro OZAWA, Yokohama (JP)

(73) Assignee: KABUSHIKI KAISHA TOSHIBA, Tokyo (JP)

(21) Appl. No.: 17/652,779

(22) Filed: Feb. 28, 2022

(30) Foreign Application Priority Data
Sep. 15, 2021 (JP) 2021-150343

(51) Int. Cl. G06N 20/20

(52) U.S. Cl. CPC G06N 20/20

(57) ABSTRACT

According to one embodiment, a machine learning model evaluation system includes processing circuitry. The processing circuitry inputs used data used for training a machine learning model and target data to be input to the machine learning model for prediction. The processing circuitry calculates first statistical information from an output which the machine learning model produces with respect to the used data. The processing circuitry calculates second statistical information from an output which the machine learning model produces with respect to the target data. The processing circuitry evaluates reliability of the machine learning model, based on a difference or a rate of change between the first and second statistical information and on a threshold value.

### CROSS-REFERENCE TO RELATED APPLICATIONS

This application is based upon and claims the benefit of priority from Japanese Patent Application No. 2021-150343, filed Sep. 15, 2021, the entire contents of which are incorporated herein by reference.

### FIELD

Embodiments described herein relate generally to a machine learning model evaluation system and method.

### BACKGROUND

Machine learning models are put to practical use in various fields, for example, as models for monitoring manufacturing processes based on manufacturing data in factories and as models for predicting disease risks based on health examination data.

However, where the tendency of data differs greatly between the time of training and the time of an actual operation, the prediction accuracy decreases, and the machine learning model deteriorates in reliability. Therefore, the machine learning model has to be updated. Differences in the tendency of data may be due to upgrade of factory equipment and a change in the ages of people undergoing health examination. In addition, it is difficult to periodically check a prediction accuracy using prediction target data of the machine learning model because teaching data is troublesome. In an actual operation, therefore, a technique is desired that can evaluate the reliability of the machine learning model without the trouble of teaching.

### BRIEF DESCRIPTION OF THE DRAWINGS

FIG. 1 is a diagram showing an example of a machine learning model evaluation system according to the first embodiment.

FIG. 2 is a diagram for illustrating a machine learning model according to the first embodiment.

FIG. 3 is a diagram for illustrating how a difference and a rate of change are in the first embodiment.

FIG. 4 is a flowchart illustrating an example of how the operation is in the first embodiment.

FIG. 5 is a flowchart illustrating an example of how the operation is in a modification of the first embodiment.

FIG. 6 is a diagram showing an example of a machine learning model evaluation system according to the second embodiment.

FIG. 7 is a flowchart illustrating an example of how the operation is in the second embodiment.

FIG. 8 is a diagram showing an example of a machine learning model evaluation system according to the third embodiment.

FIG. 9 is a flowchart illustrating an example of how the operation is in the third embodiment.

FIG. 10 is a diagram exemplifying a hardware configuration of a machine learning model evaluation system according to the fourth embodiment.

### DETAILED DESCRIPTION

In general, according to one embodiment, a machine learning model evaluation system includes processing circuitry. The processing circuitry inputs used data used for training a trained machine learning model and target data to be input to the machine learning model for prediction to the machine learning model. The processing circuitry calculates first statistical information from an output which the machine learning model produces with respect to the used data. The processing circuitry calculates second statistical information from an output which the machine learning model produces with respect to the target data. The processing circuitry evaluates reliability of the machine learning model, based on a difference or a rate of change between the first statistical information and the second statistical information and on a predetermined threshold value.

Embodiments will now be described with reference to the accompanying drawings. In the description below, reference will be made to an example in which a machine learning model evaluation system evaluates the reliability of a trained machine learning model. In order to easily understand how the machine learning model evaluation system is applied, it may be referred to using an arbitrary name, such as a machine learning model reliability evaluation system. Similarly, the trained machine learning model may be referred to as a trained model.

### First Embodiment

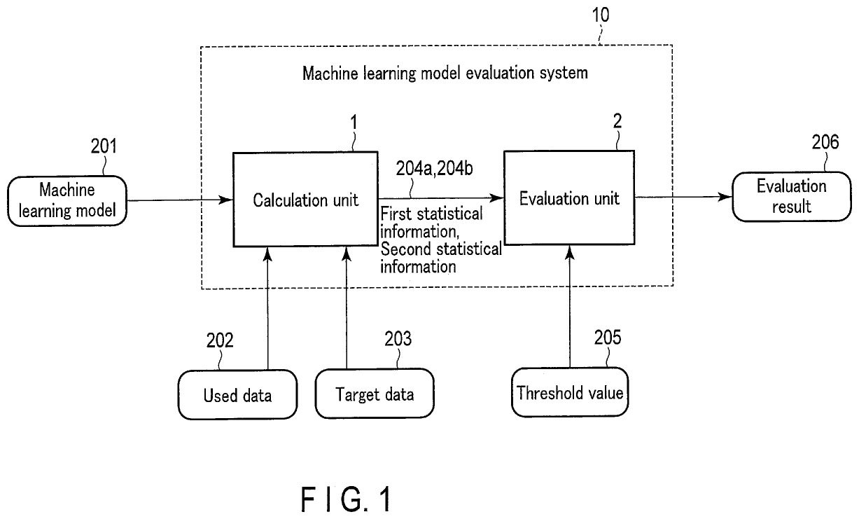

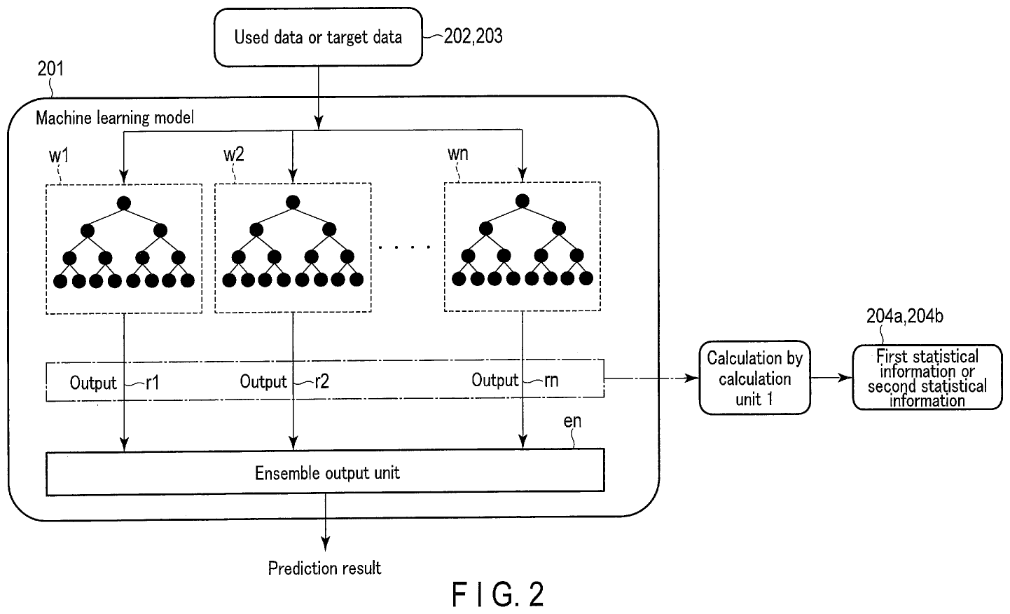

FIG. 1 is a diagram showing an example of the functional configuration of the machine learning model evaluation system 10 of the first embodiment, and FIG. 2 is a diagram for illustrating the machine learning model 201. The machine learning model evaluation system 10 includes a calculation unit 1 and an evaluation unit 2.

The calculation unit 1 receives a trained machine learning model 201, used data 202 used for training the machine learning model 201, and target data 203 supplied to the machine learning model 201 for prediction. Each of the used data 202 and the target data 203 may include two or more explanatory variables. The calculation unit 1 inputs the used data 202 and the target data 203 to the machine learning model 201.

As shown in FIG. 2, the machine learning model 201 includes a plurality of weak classifiers w1 to wn corresponding to the used data 202 or the target data 203, and an ensemble output unit en that makes a prediction by ensemble from outputs r1 to rn of the plurality of weak classifiers w1 to wn.

As each of the plurality of weak classifiers w1 to wn, decision trees of a random forest can be used, for example. Each decision tree has conditional branches related to the explanatory variables of the used data 202 and the target data 203. Where the used data 202 and the target data 203 include two or more explanatory variables, each decision tree has two or more conditional branches. Upon receipt of the used data 202 or the target data 203, the plurality of weak classifiers w1 to wn generate outputs r1 to rn representing prediction results corresponding to the input used data 202 or the target data 203. The outputs r1 to rn representing prediction results can be applied to any of regression, classification, and survival. As the outputs r1 to rn, regression results of response variables can be used in the case of regression, classification probabilities can be used in the case of classification, and a survival probability, a risk score, and a cumulative hazard rate can be used in the case of survival.

For example, the ensemble output unit en performs ensemble (majority voting or averaging) on the outputs r1 to rn of the plurality of weak classifiers w1 to wn, and generates and transmits obtained prediction results.

The calculation unit 1 calculates first statistical information 204a from outputs which the machine learning model 201 produces with respect to the used data 202, and calculates second statistical information 204b from outputs which the machine learning model 201 produces with respect to the target data 203.

The first statistical information 204a and the second statistical information 204b are values that are calculated from the standard deviation, the variance, the average value, the median value or the mode value of values output by the plurality of weak classifiers w1 to wn of the machine learning model 201. Specifically, the first statistical information 204a is, for example, an average value, a median value or a mode value that is calculated from the standard deviation, the variance, the average value, the median value or the mode value of the values which the plurality of weak classifiers w1 to wn output with respect to the used data 202. The second statistical information 204b is an average value, a median value or a mode value that is calculated from the standard deviation, the variance, the average value, the median value or the mode value of the values which the plurality of weak classifiers w1 to wn output with respect to the target data 203. In the case of regression, the standard deviation or the variance is used to see how the variation of the values output from the weak classifiers w1 to wn is. In the case of classification, classification probabilities (confidence) of respective classes are output from the weak classifiers w1 to wn, so that the average value, the median value, or the mode value may be used, alternatively the variation may be used as in the case of regression, or they may be used in combination. The index for looking at the variation is not limited to the standard deviation or the variance, and may be a coefficient of variation obtained by dividing the standard deviation by the average value. In order to easily understand how the calculation unit 1 is applied, it may be referred to using an arbitrary name, such as a statistical information calculation unit.

Referring back to FIG. 1, the evaluation unit 2 receives the first statistical information 204a, the second statistical information 204b and a predetermined threshold value 205. The threshold value 205 may be a value stored in the evaluation unit 2 in advance. The evaluation unit 2 evaluates reliability of the machine learning model 201, based on the difference or rate of change between the first statistical information 204a and the second statistical information 204b and on the predetermined threshold value 205.

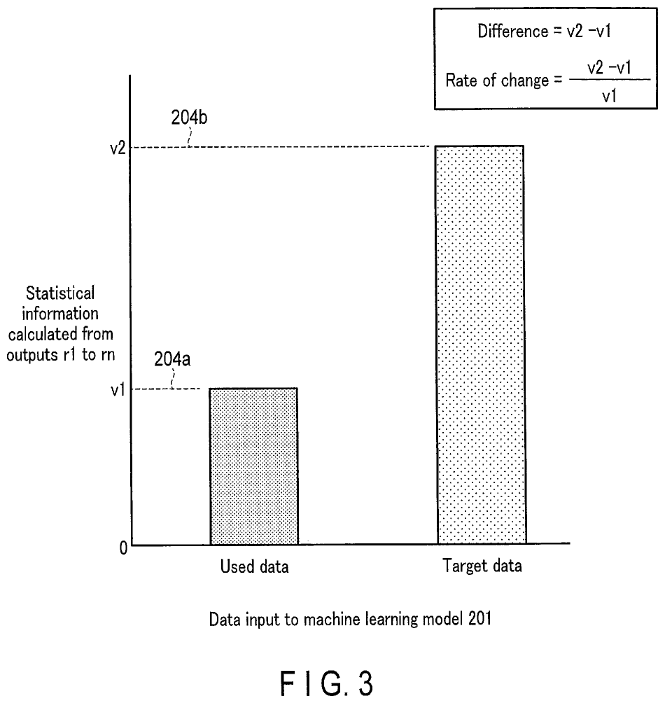

As shown in FIG. 3, the difference (=v2-v1) is obtained, for example, by subtracting the value v1 of the first statistical information 204a from the value v2 of the second statistical information 204b. The rate of change (=(v2−v1)/v1) is obtained, for example, by dividing the difference by the value v1.

For example, where the first statistical information 204a and the second statistical information 204b exceed the threshold value 205 and deviate from each other, the evaluation unit 2 determines that the machine learning model 201 is highly likely to be unsuitable for the prediction of the target data 203, and produces an evaluation result 206 indicating that the prediction result after ensemble is unreliable.

The evaluation unit 2 outputs the produced evaluation result 206. The evaluation result 206 is, for example, a binary value indicating whether or not the machine learning model 201 is reliable with respect to the target data 203. The evaluation unit 2 may also output a difference or a rate of change as reference information. Where an evaluation result 206 indicating that the machine learning model 201 is unreliable is obtained, the evaluation unit 2 may cause a display (not shown) to show an alert corresponding to the evaluation result 206, or may cause the display to show a message prompting update of the machine learning model 201. In order to easily understand how the evaluation unit 2 is applied, it may be referred to using an arbitrary name, such as a reliability evaluation unit.

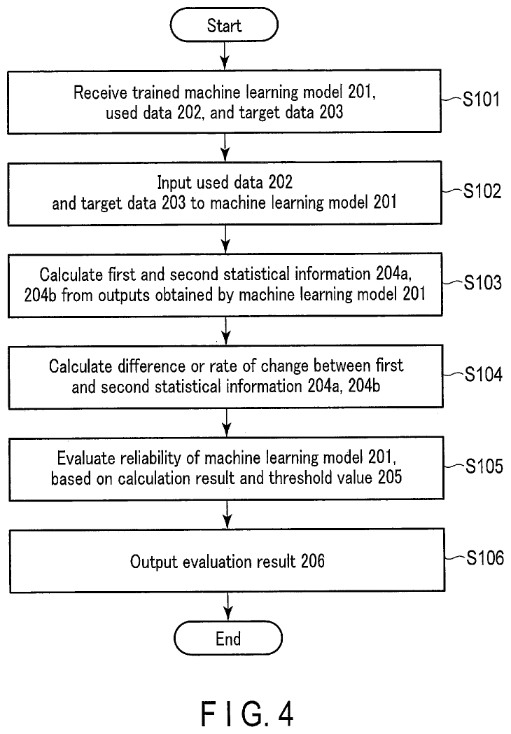

Next, a description will be given of how the machine learning model evaluation system configured as described operates, with reference to the flowchart shown in FIG. 4.

The calculation unit 1 receives a trained machine learning model 201, used data 202 used for training the machine learning model 201, and target data 203 for which prediction is to be performed by the machine learning model 201 (S101).

After step S101, the calculation unit 1 inputs the used data 202 and the target data 203 to the machine learning model 201 (S102).

After step S102, the calculation unit 1 calculates first statistical information 204a and second statistical information 204b from outputs obtained from the machine learning model 201 (S103). For example, the calculation unit 1 calculates the first statistical information 204a from the outputs r1 to rn which the weak classifiers w1 to wn produce with respect to the input used data 202. Similarly, the calculation unit 1 calculates the second statistical information 204b from the outputs r1 to rn which the weak classifiers w1 to wn produce with respect to the input target data 203. Thereafter, the calculation unit 1 transmits the obtained first statistical information 204a and second statistical information 204b to the evaluation unit 2.

After step S103, the evaluation unit 2 calculates a difference or a rate of change between the transmitted first statistical information 204a and second statistical information 204b, and obtains a calculation result (S104).

After step S104, the evaluation unit 2 evaluates reliability of the machine learning model 201, based on the calculation result of the difference or rate of change and on a threshold value 205 (S105). For example, where the calculation result exceeds a threshold value 205, the evaluation unit 2 generates an evaluation result 206 indicating that the machine learning model 201 is unreliable. Where the calculation result does not exceed the threshold value 205, the evaluation unit 2 generates an evaluation result 206 indicating that the machine learning model 201 is reliable.

After step S105, the evaluation unit 2 outputs the evaluation result 206 (S106). The evaluation unit 2 may also output the difference or rate of change calculated in step S104 as reference information.

The user of the machine learning model evaluation system 10 may update the machine learning model 201, based on the evaluation result 206. Alternatively, the user may use the evaluation result 206 for data screening in which data whose distribution is significantly different from that of the used data 202 is excluded from the target data 203, so that the machine learning model 201 can be applied without any modification. Where the machine learning model 201 is updated, the machine learning model 201 is retrained by using the target data 203 input in step S101 as the used data 202 to be used at the time of training. The retraining is performed by executing a series of steps S101 to S106 until an evaluation result 206 indicating reliability is obtained.

As described above, according to the first embodiment, the calculation unit 1 inputs the used data 202 used for training the trained machine learning model 201 and the target data 203 input to the machine learning model 201 for prediction to the machine learning model 201. The calculation unit 1 calculates first statistical information 204a from outputs which the machine learning model 201 produces with respect to the used data 202, and calculates second statistical information 204b from outputs which the machine learning model 201 produces with respect to the target data 203. The evaluation unit 2 evaluates reliability of the machine learning model 201, based on the difference or rate of change between the first statistical information 204a and the second statistical information 204b and on the predetermined threshold value 205. In this manner, the reliability of the machine learning model can be evaluated without the trouble: of teaching by using the configuration that evaluates the difference or rate of change between the two kinds of statistical information calculated from outputs of the machine learning model.

A supplemental description will be given. In order to evaluate reliability of the machine learning model 201, the first embodiment does not have to teach target data 203, so that sequential evaluation can be performed with the machine learning model 201 being operated. Where the result of evaluation shows that the reliability is low, the user is prompted to update a model that is likely to result in low prediction accuracy.

Where a machine learning model 201 is prepared and operated for each disease, as in the case where the risks of lifestyle-related diseases are predicted, there may be a case where the evaluation result 206 indicates only part of the machine learning model 201 is unreliable with respect to the target data 203. In this case, only part of the machine learning model 201 may be updated;
alternatively, the entire machine learning model 201 may be updated based on the determination that people undergoing the medical examination have changed from the time when the machine learning model 201 was trained. In any case, where a machine learning model 201 is updated, the machine learning model 201 is retrained by using the target data 203 corresponding to the evaluation result indicative of unreliability as the used data 202 to be used at the time of training.

According to the first embodiment, each of the used data 202 and the target data 203 may include two or more explanatory variables. The machine learning model 201 makes a prediction by ensemble from the outputs r1 to rn which the plurality of weak classifiers w1 to wn produce with respect to the used data 202 or the target data 203. The calculation unit 1 calculates first statistical information 204a from the outputs r1 to rn which the plurality of weak classifiers w1 to wn produce with respect to the used data 202, and calculates second statistical information 204b from the outputs r1 to rn which the plurality of weak classifiers w1 to wn produce with respect to the target data 203. As described above, according to the first embodiment, evaluation is performed based on the outputs of the plurality of weak classifiers w1 to wn, so that the evaluation result 206 is advantageously stable. For example, stable determination is enabled, as in the case where the outputs of a plurality of decision trees are averaged. Further, since a series of processes from calculation to evaluation are processes in which only inference is performed using the trained machine learning model 201, the amount of calculation can be small.

According to the first embodiment, each of the used data 202 and the target data 203 includes two or more explanatory variables, so that the first embodiment is easily applicable even if a lot of explanatory variables are included as in health examination data.

A description will be given of a comparative example. As one of the methods for determining whether a machine learning model should be updated, a technique that is based on a distribution of data, such as an average or a variance, is known. According to the technique of the comparative example, the distribution of data at the time of training and the distribution of data at the time of operation are compared with each other, and whether or not the model needs to be updated can be determined based on the comparison result. However, the technique of the comparative example has problems in that the comparison of the distributions of data is difficult if the data include variables of several tens of orders to several hundred orders, as in the case of health examination data. Even if weighting is performed in accordance with the variable importance of data, there may be a correlation between the variables, in which case the importance cannot be determined correctly. In contrast, the first embodiment can be applied to, the case where the data includes a large number of explanatory variables, as described above.

According to the first embodiment, the first statistical information 204a and the second statistical information 204b are values that are calculated based on the standard deviation, the variance, the average value, the median value, or the mode value of the values output by the plurality of weak classifiers w1 to wn of the machine learning model 201. In this manner, statistical information can be obtained by general statistical calculation, so that evaluation can be performed using statistical information that is easy for the user to understand.

### Modification of First Embodiment

A description will be given of a modification of the first embodiment. This modification is applicable to the embodiments that will be described later.

In the modification of the first embodiment, the evaluation unit 2 evaluates reliability when a predetermined time has elapsed from the latest time of the one or more evaluations performed by the machine learning model 201, or when the target data 203 has increased or decreased by a predetermined number from that latest time. The first evaluation time of the machine learning model 201 may be the time when the machine learning model 201 is created initially. The evaluation time is indicated, for example, by the date and time when an evaluation result 206 is output. Of the increase and decrease of data by the predetermined number, the increase of data by the predetermined number corresponds to the case where the number of target data 203 increases due to the accumulation of data accompanying the operation. On the other hand, the decrease of data by the predetermined number corresponds to the case where the number of accumulated target data 203 decreases due to promotion of reliability evaluation. The evaluation unit 2 is not limited to this example, and may execute reliability evaluation at any timing, periodically or irregularly.

Other configurations are similar to those the first embodiment.

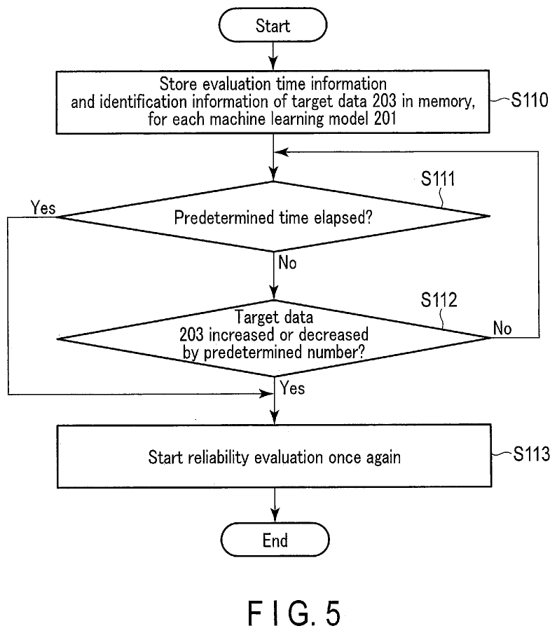

According to the modification described above, an evaluation result 206 is output in step S106, and then the evaluation unit 2 stores evaluation time information and identification information of target data 203 in a memory (not shown), for each machine learning model 201 (S110), as shown in FIG. 5.

After step S110, the evaluation unit 2 determines whether or not a predetermined time has elapsed from the latest evaluation (S111), and where the predetermined time has elapsed, the process proceeds to step S113.

Where the result of the determination in step S111 indicates that the predetermined time has not elapsed, the evaluation unit 2 determines whether or not the target data 203 has increased or decreased by a predetermined number (S112). If the target data has not, the process returns to step S111 and the processes of S111 to S112 are repeatedly executed.

On the other hand, if the result of the determination in step S112 indicates that the target data has increased or decreased by the predetermined number, the evaluation unit 2 starts reliability evaluation once again (S113). Specifically, for example, the evaluation unit 2 outputs a message to a display (not shown) once again, prompting the start of the reliability evaluation. Thereafter, a series of processes of steps S101 to S106 described above are executed.

According to the modification described above, advantages similar to those of the first embodiment are obtained, and the evaluation of the machine learning model 201 can be repeatedly executed at an appropriate point of time, so that the reliability of the machine learning model 201 can be improved.

### Second Embodiment

Next, a description will be given of a machine learning model evaluation system according to the second embodiment.

The second embodiment is a modification of the first embodiment, and has a configuration in which the above-mentioned used data 202 and the first statistical information 204a corresponding to the used data 202 are omitted.

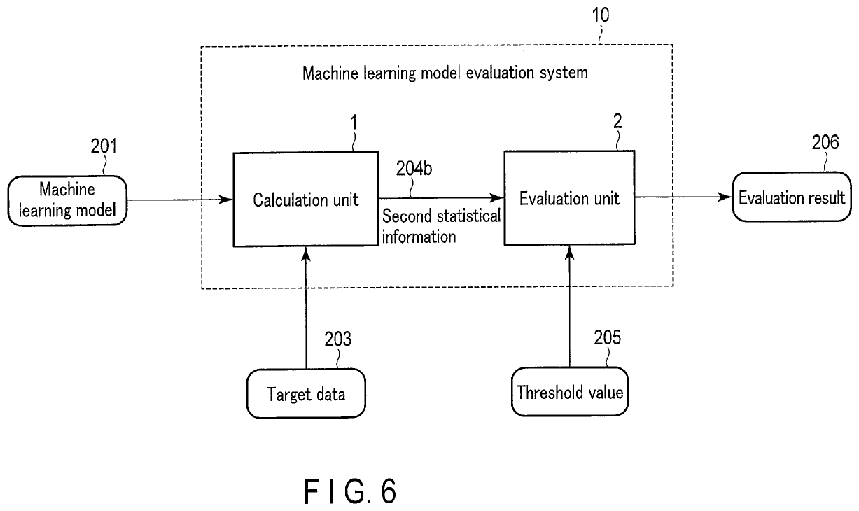

FIG. 6 is a diagram showing an example of the functional configuration of the machine learning model evaluation system 10 of the second embodiment. Components similar to the components described above are designated by the same reference numerals, and a detailed description of such components will be omitted. In the description below, different features will be mainly described. In connection with each of the embodiments described below, duplicate descriptions will be omitted.

As shown in FIG. 6, the calculation unit 1 inputs target data 203, which is input to the trained machine learning model 201 for prediction, to the machine learning model 201, and calculates second statistical information 204b from outputs of the machine learning model 201.

The evaluation unit 2 evaluates reliability of the machine learning model 201, based on the calculated second statistical information 204b and a predetermined threshold value 205.

Other configurations are similar to those the first embodiment. For example, the machine learning model 201 makes a prediction by ensemble from the outputs r1 to rn which a plurality of weak classifiers w1 to wn produce with respect to the target data 203. The calculation unit 1 calculates second statistical information 204b from the outputs r1 to rn which the plurality of weak classifiers w1 to wn produce with respect to the target data 203. The second statistical information 204b is a value calculated based on the standard deviation, the variance, the average value, the median value or the mode value of the values output by the plurality of weak classifiers w1 to wn of the machine learning model 201. The target data 203 includes two or more explanatory variables. The evaluation unit 2 may evaluate reliability when a predetermined time has elapsed from the latest time of the one or more evaluations performed by the machine learning model 201, or when the target data 203 has increased or decreased by a predetermined number from that latest time. The first evaluation time of the machine learning model 201 may be the time when the machine learning model 201 is created initially.

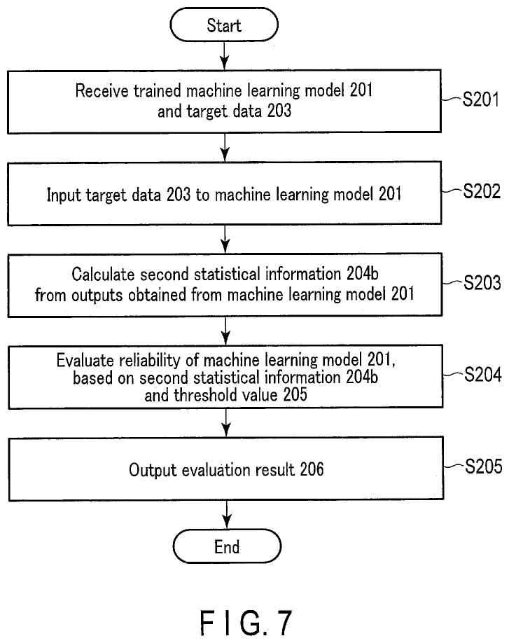

Next, a description will be given of how the machine learning model evaluation system 10 configured as described above operates, with reference to the flowchart shown in FIG. 7.

The calculation unit 1 receives a trained machine learning model 201 and target data 203 for which prediction is to be performed by the machine learning model 201 (S201).

After step S201, the calculation unit 1 inputs the target data 203 to the machine learning model 201 (S202).

After step S202, the calculation unit 1 calculates second statistical information 204b from outputs obtained from the machine learning model 201 (S203). For example, the calculation unit 1 calculates the second statistical information 204b from the outputs r1 to rn which the weak classifiers w1 to wn produce with respect to the input target data 203. Thereafter, the calculation unit 1 transmits the calculated second statistical information 204b to the evaluation unit 2.

After step S203, the evaluation unit 2 evaluates reliability of the machine learning model 201, based on the transmitted second statistical information 204b and a threshold value 205 (S204). For example, where the calculation result exceeds the threshold value 205, the evaluation unit 2 generates an evaluation result 206 indicating that the machine learning model 201 is unreliable. Where the calculation result does not exceed the threshold value 205, the evaluation unit 2 generates an evaluation result 206 indicating that the machine learning model 201 is reliable.

After step S204, the evaluation unit 2 outputs the evaluation result 206 (S205). The evaluation unit 2 may also output the second statistical information 204b calculated in step S203 as reference information.

The user of the machine learning model evaluation system 10 may update the machine learning model 201, based on the evaluation result 206. Alternatively, the user may use the evaluation result 206 for data screening in which data exceeding the threshold value 205 is excluded from the target data 203, so that the machine learning model 201 can be applied without any modification. Where the machine learning model 201 is updated, the machine learning model 201 is retrained by using the target data 203 input in step S201 as the used data 202 to be used at the time of training. The retraining is performed by executing a series of steps S201 to S205 until an evaluation result 206 indicating reliability is obtained.

As described above, according to the second embodiment, the calculation unit 1 inputs the target data 203, which is input to the trained machine learning model 201 for prediction, to the machine learning model 201, and calculates second statistical information 204b from outputs of the machine learning model 201. The evaluation unit 2 evaluates reliability of the machine learning model 201, based on the second statistical information 204b and a predetermined threshold value 205. In this manner, the reliability of the machine learning model can be evaluated without the trouble of teaching by using the configuration that evaluates the statistical information calculated from outputs of the machine learning model.

A supplemental description will be given. In the case of highly confidential data, such as health examination data, there is a high possibility that used data 202 used for training cannot be obtained if the machine learning model 201 is operated by a health insurance association different from the health insurance association that trained the machine learning model 201. Even in this case, the second embodiment enables reliability to be evaluated only from the machine learning model 201 and the target data 203, so that the versatility can be improved in addition to the advantages of the first embodiment.

According to the second embodiment, the machine learning model 201 makes a prediction by ensemble from the outputs r1 to rn which the plurality of weak classifiers w1 to wn produce with respect to the target data 203. The calculation unit 1 calculates second statistical information 204b from the outputs r1 to rn which the plurality of weak classifiers w1 to wn produce with respect to the target data 203. The second statistical information is a value calculated based on the standard deviation, the variance, the average value, the median value or the mode value of the values output by the plurality of weak classifiers w1 to wn of the machine learning model 201. The target data 203 includes two or more explanatory variables. The evaluation unit 2 may evaluate reliability when a predetermined time has elapsed from the latest time of the one or more evaluations performed by the machine learning model 201, or when the target data 203 has increased or decreased by a predetermined number from that latest time. The first evaluation time of the machine learning model 201 may be the time when the machine learning model 201 is created initially. Therefore, the second embodiment can produce advantages similar to those of the first embodiment, without using the used data 202.

### Third Embodiment

Next, a description will be given of a machine learning model evaluation system according to the third embodiment.

The third embodiment is a modification of the first and second embodiments, and is configured to input first statistical information 204a corresponding to used data 202 to the evaluation unit 2. To supplement this, the third embodiment is an embodiment in which the used data 202 cannot be obtained from the viewpoint of confidentiality, as in the second embodiment. Unlike the second embodiment, however, the third embodiment obtains the first statistical information 204a.

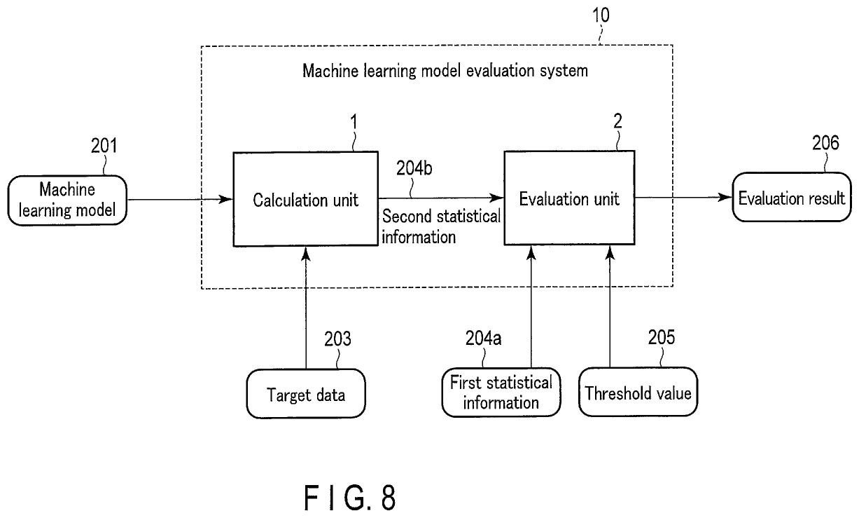

FIG. 8 is a diagram showing an example of the functional configuration of the machine learning model evaluation system 10 of the third embodiment.

As shown in FIG. 8, the calculation unit 1 inputs target data 203, which is input to the trained machine learning model 201 for prediction, to the machine learning model 201, and calculates second statistical information 204b from outputs of the machine learning model 201. The calculation unit 1 is similar to the calculation unit 1 of the second embodiment.

The evaluation unit 2 receives the calculated second statistical information 204b, and also receives first statistical information 204a that is calculated in advance based on an output obtained by inputting the used data 202 used for training the machine learning model 201 to the machine learning model 201. The evaluation unit 2 evaluates reliability of the machine learning model 201, based on the difference or rate of change between the first statistical information 204a and the second statistical information 204b and on a predetermined threshold value 205.

Other configurations are similar to those of the first or second embodiment. For example, the machine learning model 201 makes a prediction by ensemble from the outputs r1 to rn which a plurality of weak classifiers w1 to wn produce with respect to the used data 202 or the target data 203. The calculation unit 1 calculates second statistical information 204b from the outputs r1 to rn which the plurality of weak classifiers w1 to wn produce with respect to the target data 203. The first statistical information 204a and the second statistical information 204b are values calculated based on the standard deviation, the variance, the average value, the median value or the mode value of the values output by the plurality of weak classifiers w1 to wn of the machine learning model 201. Each of the used data 202 and the target data 203 includes two or more explanatory variables. The evaluation unit 2 may evaluate reliability when a predetermined time has elapsed from the latest time of the one or more evaluations performed by the machine learning model 201, or when the target data 203 has increased or decreased by a predetermined number from that latest time. The first evaluation time of the machine learning model 201 may be the time when the machine learning model 201 is created initially.

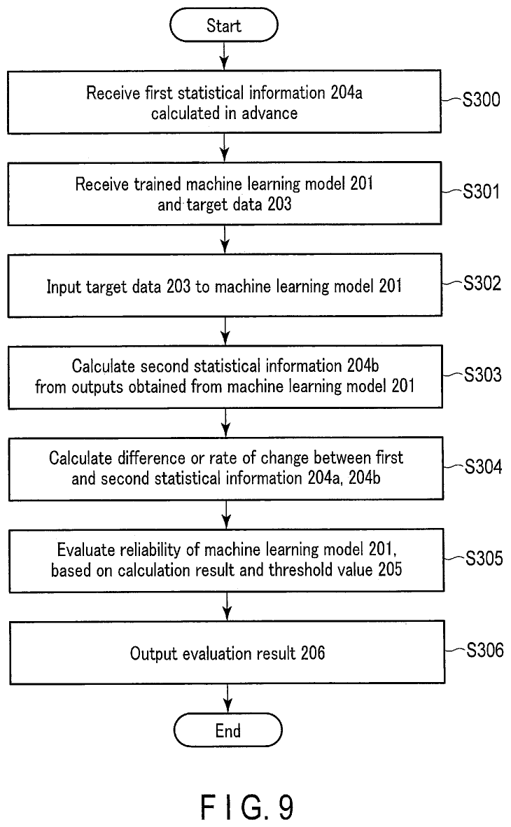

Next, a description will be given of how the machine learning model evaluation system 10 configured as described above operates, with reference to the flowchart shown in FIG. 9.

The calculation unit 1 receives first statistical information 204a that is calculated in advance based on the output obtained by inputting the used data 202 used for training the machine learning model 201 to the machine learning model 201 (S300). It should be noted that step S300 can be executed at any timing as long as it precedes step S304 described later.

After step S300, the calculation unit 1 receives trained machine learning model 201 and target data 203 for which prediction is performed by the machine learning model 201 (S301). It should be noted that step S301 may be executed before step S300.

After step S301, the calculation unit 1 inputs the target data 203 to the machine learning model 201 (S302).

After step S302, the calculation unit 1 calculates second statistical information 204b from outputs obtained from the machine learning model 201 (S303). For example, the calculation unit 1 calculates the second statistical information 204b from the outputs r1 to rn which the weak classifiers w1 to wn produce with respect to the input target data 203. Thereafter, the calculation unit 1 transmits the calculated second statistical information 204b to the evaluation unit 2.

After step S303, the evaluation unit 2 calculates a difference or a rate of change between the first statistical information 204a received in step S300 and the second statistical information 204b transmitted in step S303, and obtains a calculation result (S304).

After step S304, the evaluation unit 2 evaluates reliability of the machine learning model 201, based on the calculation result of the difference or rate of change and the threshold value 205 (S305). For example, where the calculation result exceeds a threshold value 205, the evaluation unit 2 generates an evaluation result 206 indicating that the machine learning model 201 is unreliable. Where the calculation result does not exceed the threshold value 205, the evaluation unit 2 generates an evaluation result 206 indicating that the machine learning model 201 is reliable.

After step S305, the evaluation unit 2 outputs the evaluation result 206 (S306). The evaluation unit 2 may also output the difference or rate of change calculated in step S304 as reference information.

The user of the machine learning model evaluation system 10 may update the machine learning model 201, based on the evaluation result 206. Alternatively, the user may use the evaluation result 206 for data screening in which data whose distribution is significantly different from that of the used data 202 is excluded from the target data 203, so that the machine learning model 201 can be applied without any modification. Where the machine learning model 201 is updated, the machine learning model 201 is retrained by using the target data 203 input in step S302 as the used data 202 to be used at the time of training. The retraining is performed by executing a series of steps S300 to S306 until an evaluation result 206 indicating reliability is obtained.

As described above, according to the third embodiment, the calculation unit 1 inputs the target data 203, which is input to the trained machine learning model 201 for prediction, to the machine learning model 201, and calculates second statistical information 204b from outputs of the machine learning model 201. In addition, the evaluation unit 2 receives the calculated second statistical information 204b, and also receives first statistical information 204a that is calculated in advance based on an output obtained by inputting the used data 202 used for training the machine learning model 201 to the machine learning model 201. The evaluation unit 2 evaluates reliability of the machine learning model 201, based on the difference or rate of change between the first statistical information 204a and the second statistical information 204b and on a predetermined threshold value 205. In this manner, the reliability of the machine learning model can be evaluated without the trouble of teaching by using the configuration that evaluates the statistical information calculated from outputs of the machine learning model.

A supplemental description will be given. According to the third embodiment, even if the used data 202 cannot be obtained from the viewpoint of confidentiality, the first statistical information 204a calculated in advance from the machine learning model 201 and the used data 202 can be input, so that the reliability can be evaluated in a similar manner to that of the first embodiment. That is, according to the third embodiment, the reliability can be evaluated only from the machine learning model 201, the target data 203, and the first statistical information 204a. Therefore, the versatility can be improved in addition to the advantages of the first embodiment.

The machine learning model 201 makes a prediction by ensemble from the outputs r1 to rn which the plurality of weak classifiers w1 to wn produce with respect to the used data 202 or the target data 203. The calculation unit 1 calculates second statistical information 204b from the outputs r1 to rn which the plurality of weak classifiers w1 to wn produce with respect to the target data 203. The first statistical information 204a and the second statistical information 204b are values calculated based on the standard deviation, the variance, the average value, the median value or the mode value of the values output by the plurality of weak classifiers w1 to wn of the machine learning model 201. Each of the used data 202 and the target data 203 includes two or more explanatory variables. The evaluation unit 2 may evaluate reliability when a predetermined time has elapsed from the latest time of the one or more evaluations performed by the machine learning model 201, or when the target data 203 has increased or decreased by a predetermined number from that latest time. The first evaluation time of the machine learning model 201 may be the time when the machine learning model 201 is created initially. Therefore, the third embodiment can produce advantages similar to those of the first embodiment by using the configuration which inputs the first statistical information 204a without inputting the used data 202.

### Fourth Embodiment

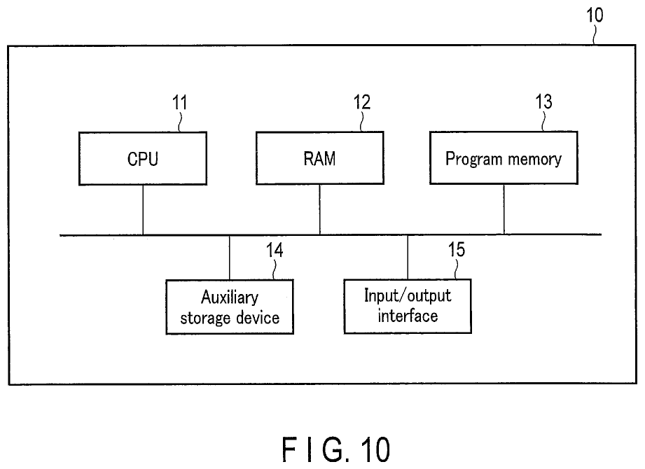

FIG. 10 is a block diagram illustrating a hardware configuration of a machine learning model evaluation system according to the fourth embodiment. The fourth embodiment is a specific example of the first to third embodiments, and is an embodiment in which the machine learning model evaluation system 10 is realized by a computer.

The machine learning model evaluation system 10 includes a CPU (Central Processing Unit) 11, a RAM (Random Access Memory) 12, a program memory 13, an auxiliary storage device 14, and an input/output interface 15 as hardware elements. The CPU 11 communicates with the RAM 12, the program memory 13, the auxiliary storage device 14, and the input/output interface 15 via a bus. That is, the machine learning model evaluation system 10 of the present embodiment is realized by a computer having such a hardware configuration.

The CPU 11 is an example of a general-purpose processor. The RAM 12 is used as a working memory by the CPU 11. The RAM 12 includes a volatile memory such as an SDRAM (Synchronous Dynamic Random Access Memory). The program memory 13 stores a program for realizing each unit or component of each embodiment. This program may be, for example, a program that causes a computer to realize each of the functions of the calculation unit 1 and the evaluation unit 2 described above. As the program memory 13, for example, a ROM (Read-Only Memory), a portion of the auxiliary storage device 14, or a combination of these is used. The auxiliary storage device 14 stores data in a non-temporary manner. The auxiliary storage device 14 includes a nonvolatile memory such as an HDD (hard disc drive) or an SSD (solid state drive).

The input/output interface 15 is an interface for coupling to another device. The input/output interface 15 is used, for example, for coupling to a keyboard, a mouse and a display.

The program stored in the program memory 13 includes computer-executable instructions. When the program (computer executable instruction) is executed by the CPU 11, which is a processing circuit, it causes the CPU 11 to execute predetermined processes. For example, when the program is executed by the CPU 11, it causes the CPU 11 to execute a series of processes described in relation to the elements shown in FIGS. 1, 6 and 8. For example, when the computer-executable instruction included in the program is executed by the CPU 11, it causes the CPU 11 to execute a machine learning model evaluation method. The machine learning model evaluation method may include a step corresponding to each function of the calculation unit 1 and the evaluation unit 2 described above. Further, the machine learning model evaluation method may appropriately include the steps shown in FIGS. 4, 7, and 9.

The program may be provided for the machine learning model evaluation system 10, which is a computer, in a state in which the program is stored in a computer-readable storage medium. In this case, the machine learning model evaluation system 10 further includes, for example, a drive (not shown) for reading data from the storage medium, and acquires a program from the storage medium. As the storage medium, for example, a magnetic disc, an optical disc (CD-ROM, CD-R, DVD-ROM, DVD-R, etc.), a photomagnetic disc (MO, etc.), a semiconductor memory or the like can be used as appropriate. The storage medium may be referred to as a non-transitory computer readable storage medium. Alternatively, the program may be stored in a server on a communication network such that the machine learning model evaluation system 10 can download the program from the server using the input/output interface 15.

The processing circuit for executing the program is not limited to a general-purpose hardware processor such as a CPU 11, and a dedicated hardware processor such as an ASIC (Application Specific Integrated Circuit) may be used. The term “processing circuit (processing unit)” covers at least one general-purpose hardware processor, at least one dedicated hardware processor, or a combination of at least one general purpose hardware processor and at least one dedicated hardware processor. In the example shown in FIG. 10, the CPU 11, the RAM 12 and the program memory 13 correspond to the processing circuit.

According to at least one embodiment described above, the reliability of the machine learning model can be evaluated without the trouble of teaching.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A machine learning model evaluation system comprising processing circuitry configured to:
input used data used for training a trained machine learning model and target data to be input to the machine learning model for prediction to the machine learning model;
calculate first statistical information from an output which the machine learning model produces with respect to the used data;
calculate second statistical information from an output which the machine learning model produces with respect to the target data; and
evaluate reliability of the machine learning model, based on a difference or a rate of change between the first statistical information and the second statistical information and on a predetermined threshold value.

2. The machine learning model evaluation system according to claim 1, wherein the machine learning model makes a prediction by ensemble from outputs which a plurality of weak classifiers produce with respect to the used data or the target data.

3. The machine learning model evaluation system according to claim 2, wherein the processing circuitry is further configured to:
calculate the first statistical information from the outputs which the plurality of weak classifiers produce with respect to the used data; and
calculate the second statistical information from the outputs which the plurality of weak classifiers produce with respect to the target data.

4. A machine learning model evaluation system comprising processing circuitry configured to:
input target data to be input to a trained machine learning model for prediction to the machine learning model;
calculate second statistical information from an output which the machine learning model produces; and
evaluate reliability of the machine learning model, based on the second statistical information and a predetermined threshold value.

5. The machine learning model evaluation system according to claim 4, wherein the machine learning model makes a prediction by ensemble from outputs which a plurality of weak classifiers produce with respect to the target data.

6. The machine learning model evaluation system according to claim 5, wherein the processing circuitry is further configured to calculate the second statistical information from the outputs which the plurality of weak classifiers produce with respect to the target data.

7. The machine learning model evaluation system according to claim 5, wherein the second statistical information is a value calculated based on a standard deviation, a variance, an average value, a median value or a mode value of values output by the plurality of weak classifiers of the machine learning model.

8. The machine learning model evaluation system according to claim 7, wherein the target data includes two or more explanatory variables.

9. A machine learning model evaluation system comprising processing circuitry configured to:
input target data to be input to a trained machine learning model for prediction to the machine learning model;
calculate second statistical information from an output which the machine learning model produces;
upon receiving the second statistical information and first statistical information that is calculated in advance based on an output obtained by inputting used data used for training the machine learning model to the machine learning model, evaluate reliability of the machine learning model, based on a difference or a rate of change between the first statistical information and the second statistical information and on a predetermined threshold.

10. The machine learning model evaluation system according to claim 9, wherein the machine learning model makes a prediction by ensemble from outputs which a plurality of weak classifiers produce with respect to the used data or the target data.

11. The machine learning model evaluation system according to claim 10, wherein the processing circuitry is further configured to calculate the second statistical information from the outputs which the plurality of weak classifiers produce with respect to the target data.

12. The machine learning model evaluation system according to claim 2, wherein the first statistical information and the second statistical information are values calculated based on a standard deviation, a variance, an average value, a median value or a mode value of values output by the plurality of weak classifiers of the machine learning model.

13. The machine learning model evaluation system according to claim 12, wherein each of the used data and the target data includes two or more explanatory variables.

14. The machine learning model evaluation system according to claim 13, wherein the processing circuitry is further configured to evaluate the reliability when a predetermined time has elapsed from a latest time of one or more evaluations performed by the machine learning model, or when the target data has increased or decreased by a predetermined number from the latest time.

15. A machine learning model evaluation method comprising:
inputting used data used for training a trained machine learning model and target data to be input to the machine learning model for prediction to the machine learning model;
calculating first statistical information from an output which the machine learning model produces with respect to the used data, and calculating second statistical information from an output which the machine learning model produces with respect to the target data; and
evaluating reliability of the machine learning model, based on a difference or a rate of change between the first statistical information and the second statistical information and on a predetermined threshold value.
